(19) United States
(12) Patent Application Publication
(10) Pub. No.: US 2009/0125750 A1
(43) Pub. Date: May 14, 2009

(54) USING MEMORIES TO CHANGE DATA PHASE OR FREQUENCY

(76) Inventors: Jae-hyoung Park, Asan-si (KR); Woo-chul Kim, Seoul (KR); Ik-hyun Ahn, Cheonan-si (KR); Nam-gon Choi, Asan-si (KR); Dong-hyun Yeo, Goyang-si (KR); Young-su Han, Namdong-gu (KR)

Correspondence Address: Haynes and Boone, LLP;IP Section, 2323 Victory Avenue, SUITE 700, Dallas, TX, 75219, US

(21) Appl. No.: 12/116,762

(22) Filed: May 7, 2008

(30) Foreign Application Priority Data
Nov. 13, 2007 (KR) 10-2007-0115575

(51) Int. Cl. G06F 13/00; G06F 12/00; G06F 1/12; G06F 3/00

(52) U.S. Cl. 713/600; 710/60; 710/61; 711/E12.001

(57) ABSTRACT

A data processing apparatus includes a first memory which comprises a first input/output port and a second input/output port; a second memory which is connected to the first memory and comprises a third input/output port; and a controller for controlling the first and second memories to perform operations of: (a) writing data to the first memory through the first input/output port; (b) reading the data from the first memory through the second input/output port; (c) writing the data read out of the first memory to the second memory through the third input/output port; and (d) reading the data from the second memory through the third input/output port; wherein the operation (a) is performed at a first frequency and the operations (b), (c), (d) are each performed at a second frequency, wherein either: (i) the first frequency is different from the second frequency, or (ii) the first frequency is equal to the second frequency but in each of the operations (b), (c) and (d) the data is different in phase than in the operation (a).

### CROSS-REFERENCE TO RELATED APPLICATION

This application claims priority from South Korean Patent Application No. 10-2007-115575, filed on Nov. 13, 2007 in the Korean Intellectual Property Office, the disclosure of which is incorporated herein by reference.

### BACKGROUND OF INVENTION

1. Field of Invention

The present invention relates to memory systems that can be used to convert data from one frequency or phase to another frequency or phase.

2. Description of Related Art

In data processing, different operations may be performed at different clock frequencies, and it may be needed to change the data frequency. For example, computer displays become increasingly diversified in function, and different functions may be performed on image data at different frequencies. A static random access memory (SRAM) can be used for data frequency conversion. Either a single port SRAM (SPSRAM) or a dual port SRAM (DPSRAM) can be used. The DPSRAM can be read and written simultaneously, but is two or times or more times larger in area than the SPSRAM of the same capacity. This is a significant disadvantage due to the limited space available on circuit boards, especially since the display sizes have been increasing to require larger and larger memories for storage of image data.

### SUMMARY

This section summarizes some features of some embodiments of the present invention. Other features are described in subsequent sections. The invention is defined by the appended claims.

Some embodiments of the present invention provide a data processing apparatus having a simple configuration and a small size, which can change data frequency using simple operation and has a large data storage.

Thus, some embodiments provide a data processing apparatus comprising: a first memory which comprises a first input/output port and a second input/output port; a second memory which is connected to the first memory and comprises a third input/output port; and a controller for controlling the first and second memories to perform operations of: (a) writing data to the first memory through the first input/output port; (b) reading the data from the first memory through the second input/output port; (c) writing the data read out of the first memory to the second memory through the third input/output port; and (d) reading the data from the second memory through the third input/output port; wherein the operation (a) is performed at a first frequency and the operations (b), (c), (d) are each performed at a second frequency, wherein either: (i) the first frequency is different from the second frequency, or (ii) the first frequency is equal to the second frequency but in each of the operations (b), (c) and (d) the data is different in phase than in the operation (a).

In some embodiments, the first input/output port comprises a first clock terminal for receiving a clock signal for synchronizing the operation (a), and the second input/output port comprises a second clock terminal for receiving a clock signal for synchronizing the operation (b), and wherein the controller applies a first clock signal to the first clock terminal and at the same time applies a second clock signal to the second clock terminal, the first and second clock signals being different in phase or in frequency, and the controller controls the first memory so that the operations (a) and (b) overlap.

In some embodiments, the data is read from the first memory sequentially in the order in which it was written to the first memory.

In some embodiments, the third input/output port comprises a third clock terminal for synchronizing the operations (c) and (d), and the controller applies the second clock signal to the third clock terminal.

In some embodiments, the first frequency is different from the second frequency.

In some embodiments, the second frequency is n times the first frequency, where n is an integer greater than one.

In some embodiments, the data is read from the first memory n times at the second frequency.

In some embodiments, the first and second clock signals have the same frequency but are different in phase.

Some embodiments comprise a clock generator for generating the first and second clock signals having different frequencies.

In some embodiments, the first memory has a smaller capacity than the second memory.

Some embodiments provide a data processing apparatus comprising: a first memory which comprises a first clock terminal and a second clock terminal; a second memory which comprises a third clock terminal; and a controller for providing a first clock signal to the first clock terminal for writing data to the first memory, a second clock signal to the second clock terminal for reading data from the first memory, the second clock signal being different from the first clock signal, and for providing the second clock to the second memory for writing the second memory with the data read from the first memory and for reading the data from the second memory.

In some embodiments, the first clock signal and the second clock signal are simultaneously applied to the first memory to simultaneously write and read the first memory.

In some embodiments, the first and second clock signals are different in frequency.

In some embodiments, the first and second clock signals are different in phase.

Some embodiments provide a method for controlling a data processing apparatus comprising a first memory which comprises a first input/output port and a second input/output port, the data processing apparatus also comprising a second memory which comprises a third input/output port, the method comprising: (a) writing data to the first memory through the first input/output port; (b) reading the data from the first memory through the second input/output port; (c) writing the data read from the first memory to the second memory through the third input/output port; and (d) reading the data from the second memory through the third data input/output port; wherein operations (b), (c), (d) are performed at the same frequency.

In some embodiments, the operation (a) is performed at a first frequency, and the frequency at which the operations (b), (c), (d) are performed is a second frequency which is n times the first frequency, where n is an integer greater than one, and in the operation (b) the data is read n times from the first memory at the second frequency.

In some embodiments, the operation (a) is performed at the same frequency as the operations (b), (c), (d), said frequency being a frequency of a first clock signal synchronizing the operation (a) and also being a frequency of a second clock signal synchronizing the operations (b), (c), (d), the first and second clock signals being different in phase.

### BRIEF DESCRIPTION OF DRAWINGS

FIG. 1 is a block diagram of a memory system according to an exemplary embodiment of the present invention.

FIG. 2 is a set of timing diagrams illustrating operation of a memory system according to an exemplary embodiment of the present invention.

FIG. 3 is a set of timing diagrams illustrating operation of a memory system according to an exemplary embodiment of the present invention.

FIG. 4 is a flowchart illustrating operation of a memory system according to an exemplary embodiment of the present invention.

FIG. 5 is a block diagram of a timing controller incorporating memory systems according to an exemplary embodiment of the present invention.

### DETAILED DESCRIPTION OF EXEMPLARY EMBODIMENTS OF INVENTION

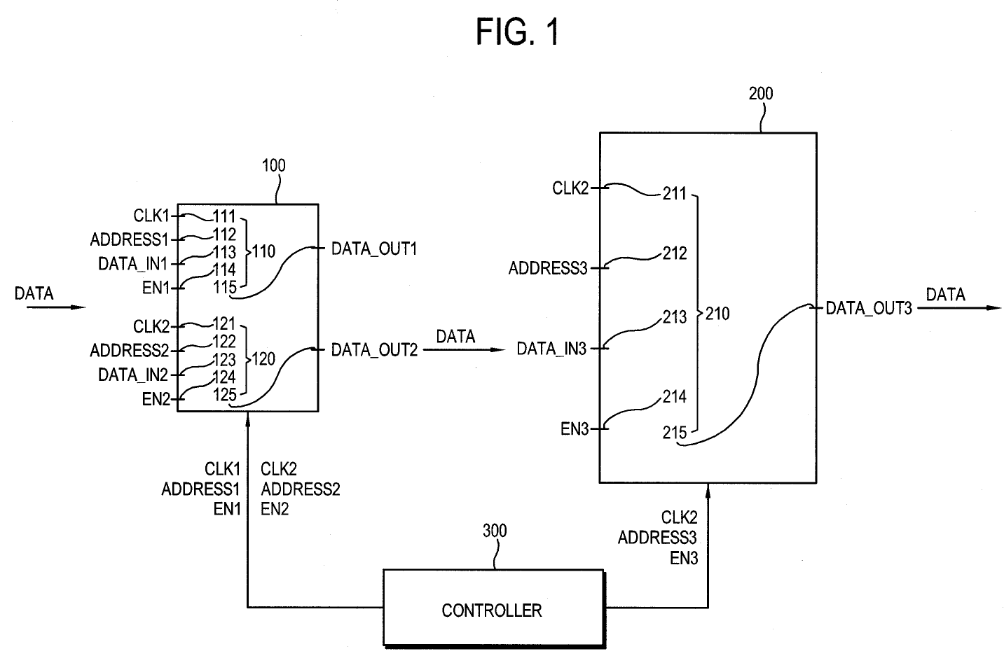

FIG. 1 is a block diagram of a data processing apparatus according to an exemplary embodiment of the present invention. The data processing apparatus of FIG. 1 is a memory system which includes a first memory 100, a second memory 200 and a controller 300 which controls the first memory 100 and the second memory 200. The first memory 100 and the second memory 200 may be volatile random access memories (RAM), i.e. memories whose locations can be read or written in any order. In particular, the first memory 100 and the second memory 200 may be static random access memories (SRAM), i.e. memories whose locations can continuously retain data while power is being supplied.

The first memory 100 includes a first input/output port 110 and a second input/output port 120. The first input/output port 110 includes a first clock terminal 111, a first address terminal 112, a first data input port 113, a first enable port 114 and a first data output port 115. The second data input/output port 120 includes a second clock terminal 121, a second address terminal 122, a second data input port 123, a second enable port 124 and a second data output port 125. The first input/output port 110 and the second input/output port 120 can be used in parallel for simultaneous accesses to the first memory 100.

The first clock terminal 111 and the second clock terminal 121 receive respective clock signals CLK1 and CLK2 used for clocking read and write operations. The clock signals CLK1 and CLK2 may have the same or different clock frequencies. Also, the clock signals CLK1 and CLK2 may differ in phase or amplitude.

The first address terminal 112 and the second address terminal 122 receive respective address information ADDRESS1 and ADDRESS2 designating read and write addresses for the first memory 100. In some embodiments, for example, the first memory 100 includes 64 addressable locations each of which can store 30 bits of data, and each of the addresses ADDRESS1, ADDRESS2 may have any value from 1 to 64. The data is read or written at the addresses specified by the address information ADDRESS1 and ADDRESS2.

The first data input port 113 and the second data input port 123 can receive read data shown respectively as DATA_IN1 and DATA_IN2, and the first data output port 115 and the second data output port 125 can provide write data shown respectively as DATA_OUT1 and DATA_OUT2.

The first enable port 114 and the second enable port 124 receive respective enable signals EN1 and EN2 which specify a read operation or a write operation. For a write operation, the respective enable signal EN1 or EN2 is low. When a write operation is not in progress, the respective enable signal EN1 or EN2 is high. In other embodiments, the respective enable signal EN1 or EN2 is low for a read operation, and is high when a read operation is not in progress.

The second memory 200 is connected to the first memory 100 to store the data read out of the first memory 100. The second memory 200 includes a third input/output port 210 which includes a third clock terminal 211, a third address terminal 212 (for address information ADDRESS3), a third data input port 213, a third enable port 214 (for the enable signal EN3), and a third data output port 215. The second memory 200 is a single port memory, having only one input/output port 210, so the second memory 200 can perform only one read or write operation at any given time. It is thus impossible to read and write the second memory 200 at the same time. In contrast, the first memory 100 is dual ported. Because a single port memory has fewer ports than a dual port memory, a single port memory has a smaller physical area than a dual port memory of the same capacity. In the present embodiment, the second memory 200 stores the data which passed through the first memory 100, and the second memory 200 may have a larger capacity than the first memory 100.

The controller 300 outputs control signals to the ports of the first memory 100 and the second memory 200. The control signals include the clock signals CLK1 and CLK2, the address information ADDRESS1, ADDRESS2, and ADDRESS3, and the enable signals EN1, EN2 and EN3. The data is read or written at addresses designated by the address information ADDRESS1, ADDRESS2 and ADDRESS3 as specified by the enable signals EN1, EN2 and EN3 and the clock signals CLK1 and CLK2.

The controller 300 may control the first memory 100 to accept data at a first clock frequency and to provide the data at a second clock frequency, thus possibly changing the data frequency. The data read out from the first memory 100 is written to the second memory 200 at the second clock frequency and then is read out for external use.

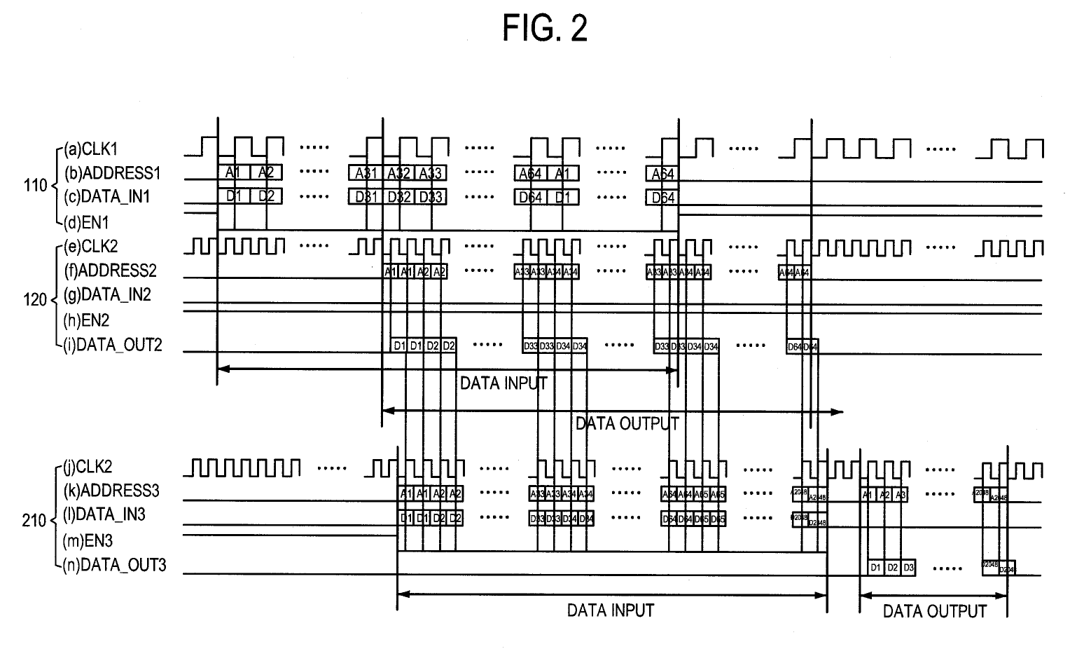

FIG. 2 includes signal waveform diagrams (a) through (n) illustrating the operation of the memory system according to one embodiment of the present embodiment. Diagram (a) illustrates the first clock signal CLK1 provided to the first clock terminal 111 of the first memory 100. Diagrams (b) and (c) illustrate the address information ADDRESS1 and the data DATA-IN1, which are provided synchronously with the first clock signal CLK1. The address information ADDRESS1 includes a sequence of addresses A1, A2, . . . , A64. The data DATA-IN1 includes data pieces D1, D2, . . . , D64 which are to be stored at the respective addresses A1, A2, . . . , A64. Diagram (d) illustrates the enable signal EN1. According to the present embodiment, the data DATA-IN1 is written to the first memory 100 when the enable signal EN1 is low.

The first memory 100 includes 64 addressable locations with addresses A1 to A64. In the example shown, the data D1 to D64 may be stored at the respective addresses A1 to A64. Subsequent data may again be stored starting from the address A1.

When the data D31 is written to the 31th address A31 of the first memory 100, the controller 300 applies the address information ADDRESS2 (diagram (f)) to the second address terminal 122 synchronously with the second clock signal CLK2 (diagram (e)) applied to the second clock terminal 121. As shown in FIG. 2, the frequency of the second clock signal CLK2 is twice the frequency of the first clock signal CLK1.

The address information ADDRESS2 sequentially designates the 64 addresses A1 through A64. Each of these addresses is applied in two consecutive cycles of the second clock signal CLK2. Therefore, each memory location A1 through A64 is read twice to the second data output terminal 125 (terminal DATA_OUT2), as shown in diagram (i). While the data is written via the first input/output port 110 and read out at the second input/output port 120, the first data output port 115 and the second data input port 123 are unused. Diagram (g) illustrates that no action is taking place on the second data input port 123. Also, while the data is read out of the first memory 100, a high signal is applied to the second enable port 124 of the second input/output port 120 as shown in diagram (h).

When data is written to any location A1, . . . , A64 of the first memory 100, the data can be read out of this location after one period of the first clock signal CLK1.

If the second clock frequency (i.e. the frequency of the second clock signal CLK2) is n times the first clock frequency (the frequency of the first clock signal CLK1), where n is some integer, then the data is read n times from the first memory 100.

The data read out of the first memory 100 is written to the second memory 200 (diagram (l)) synchronously with the second clock signal CLK2 (diagram (j)) having the second clock frequency. In this operation, the address information ADDRESS3 provides the same address during two cycles of the second clock signal CLK2 (diagram (k)), and the same data DATA-IN3 is written to this address twice (diagram (1)).

The second memory 200 includes 2048 addressable locations and has a larger capacity than the first memory 100. The data is written starting from the first location and continuing to the 2048th location, and is read out from the second memory 200 synchronously with the same second clock signal CLK2. When the data is read out, the address information ADDRESS3 provides each address in one clock cycle of the second clock signal CLK2 (diagram (k)), and therefore each location is read once to the third data output DATA_OUT3 (diagram (n)). When the data is written, the enable signal EN3 is low; and when the data is read, the enable signal EN3 is high (diagram (m)).

The second memory 200 may provide data even as subsequent data are being written to the first memory 100. The data is written to the memory system of FIG. 1 synchronously with the first clock signal CLK1 at the first clock frequency and is read out synchronously with the second clock signal CLK2 at the second clock frequency.

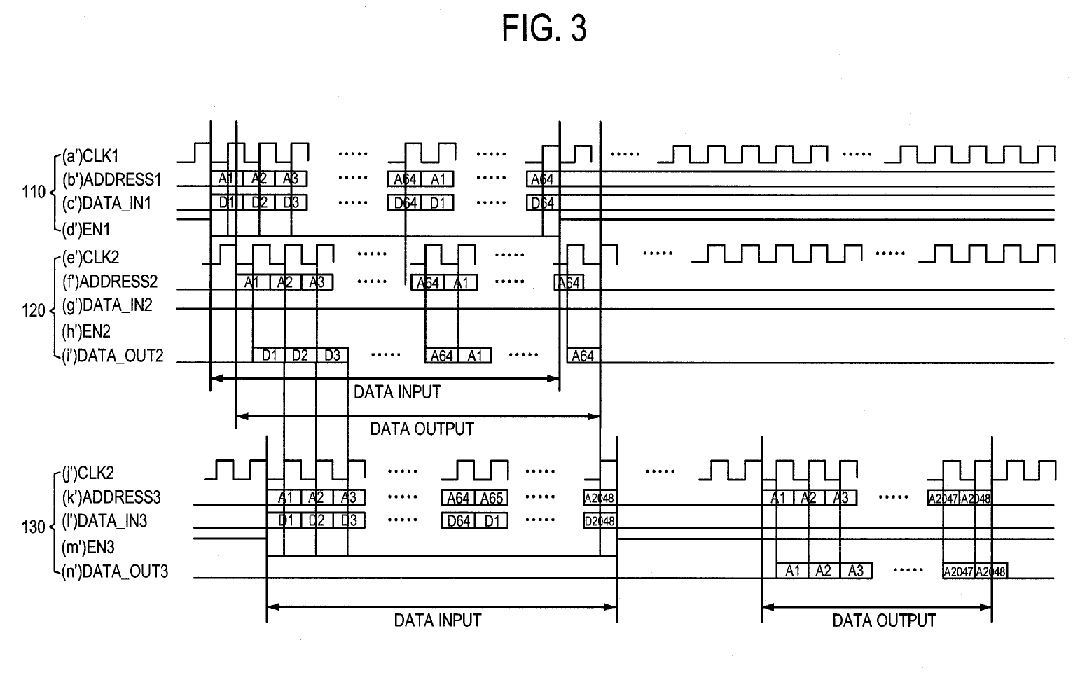

FIG. 3 includes signal waveform diagrams (a′) through (n′) showing the same signals as in FIG. 2 for another exemplary embodiment. The diagrams (a′) through (n′) show the same respective signals as the diagrams (a) through (n) in FIG. 2, and these signals will not be described any further. In the example of FIG. 3, the first and second clock signals CLK1, CLK2 have the same frequency (i.e. the first clock frequency is equal to the second clock frequency). The first and second clock signals CLK1, CLK2 also have the same amplitude but are different in phase. Thus, the memory system of FIG. 1 allows not only changing the data frequency but also changing the phase, with the clock signals CLK1 and CLK2 being shifted relative to each other.

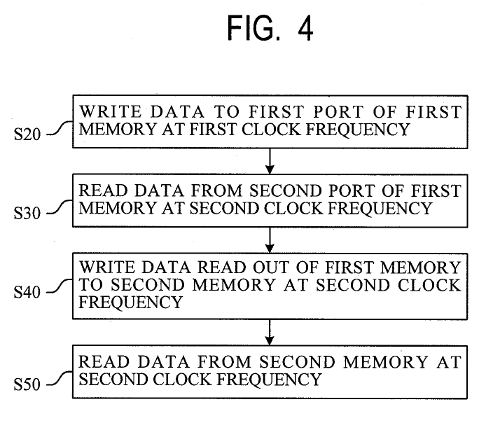

FIG. 4 is a flowchart illustrating operation of the memory system of FIG. 1 according to some embodiments of the present invention. According to FIG. 4, the first memory (100) has at least two ports and the second memory (200) has at least one port. The two memories will be used for changing the data frequency, but may also be used for changing the data phase without changing the frequency. The first memory includes the first input/output port 110 and the second input/output port 120, and the second memory 200 includes the third input/output port 210.

The data is continuously written to the first memory 100 at the first clock frequency (step S20). The controller 300 causes the stored data to be read from the first memory 100 at the second clock frequency (step S30). In particular, the controller 300 simultaneously provides the first clock signal CLK1 to the first clock terminal 111 and the second clock signal CLK2 to the second clock terminal 121 and provides the address information ADDRESS1 to the first address terminal 112 and the address information ADDRESS2 to the second address terminal 122. Consequently, the first memory 100 simultaneously performs read and write operations. When any data is stored in the first memory 100, the data can be read out after one period of the first clock signal CLK1. The controller 300 provides the second clock signal CLK2 to the second clock terminal 121 and the address information ADDRESS2 to the second address terminal 122 to accomplish the reading operation. The address sequence A1 through A64 can be repeatedly provided as information ADDRESS1 and ADDRESS2 to the first memory 100 in a continuous manner with wrap-around; the data is sequentially written and read at the corresponding addresses. The data frequency is changed as the data passes through the first memory 100.

The data read out of the first memory 100 is written to the second memory 200 at the second clock frequency (step S40). To enable the second memory 200 to store the data at the second frequency, the second memory 200 may have to be of larger capacity than the first memory 100.

Then the controller 300 causes the second memory 200 to provide the data at the second clock frequency (step S50).

The operation is similar if the first and second clocks CLK1, CLK2 have the same frequency but different phase.

As described above, in some embodiments of the present invention, two memories 100 and 200 are used to change data phase or frequency. More specifically, the phase or frequency is changed by transferring the data through the first memory 100 having small capacity. At the same time large amounts of data can stored in the second memory 200 having large capacity. Accordingly, large amounts of data can be stored using a simple circuit.

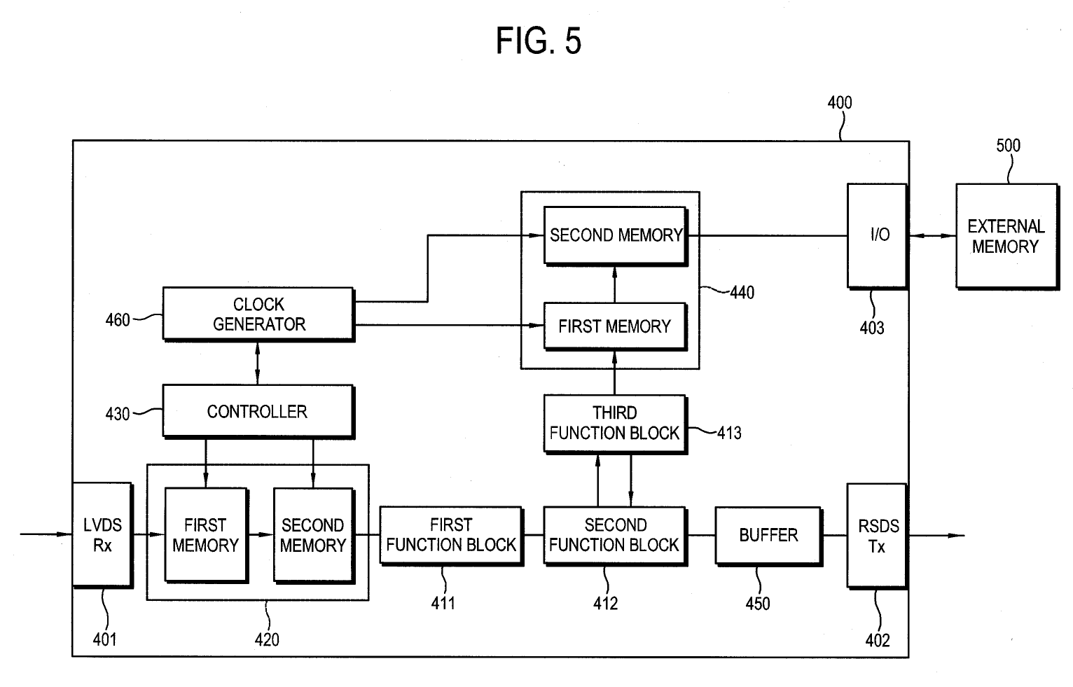

FIG. 5 is a block diagram of a timing controller 400 according to an exemplary embodiment of the present invention. The timing controller 400 can be used in a liquid crystal display or an organic light emitting display to process image signals received from an external source for display on a display panel. The timing controller 400 includes a plurality of input ports which receive the image signals and various control signals, and a plurality of output ports which output these signals.

As shown in FIG. 5, the timing controller 400 includes an LVDS Rx terminal 401 as an input port which receives the image signal, an RSDS Tx terminal 402 which outputs various signals to the display panel, and an I/O port 403 through which the data is read from or written to an external memory 500. Further, the timing controller 400 includes function blocks 411, 412 and 413 and may include a buffer 450 for data buffering. The function blocks 411, 412 and 413 may use the same or different clock frequencies.

Before the data received at the LVDS Rx terminal 401 is provided to the first function block 411, the data frequency is changed by transferring the data through a first memory system 420 including a first memory and a second memory.

The timing controller 400 also includes a second memory system 440 between the third function block 413 and the I/O port 403. The data frequency is changed by the second memory system 440.

The second memory system 440 is controlled by a controller 430. The second memory system 440 uses a first clock signal and a second clock signal that are generated by a clock generator 460 which may or may not be part of the controller 430. The clock generator 460 may generate the clock signals of desired frequencies using a phase locked loop (PLL) or in some other way.

The invention is not limited to the particulars of the timing controller 400 shown in FIG. 5. Further, the invention is not limited to displays, but is applicable to other circuits in which conversion of data phase of frequency is desired. Some embodiments have small size and simple configuration as illustrated above. High reliability and large data storage can be provided. In some embodiments, the manufacturing costs are low.

The invention is not limited to the embodiments described above but is defined by the appended claims.

What is claimed is:

1. A data processing apparatus comprising:
a first memory which comprises a first input/output port and a second input/output port;
a second memory which is connected to the first memory and comprises a third input/output port; and
a controller for controlling the first and second memories to perform operations of:
(a) writing data to the first memory through the first input/output port;
(b) reading the data from the first memory through the second input/output port;
(c) writing the data read out of the first memory to the second memory through the third input/output port; and
(d) reading the data from the second memory through the third input/output port;
wherein the operation (a) is performed at a first frequency and the operations (b), (c), (d) are each performed at a second frequency, wherein either:
(i) the first frequency is different from the second frequency, or
(ii) the first frequency is equal to the second frequency but in each of the operations (b), (c) and (d) the data is different in phase than in the operation (a).

2. The data processing apparatus according to claim 1, wherein the first input/output port comprises a first clock terminal for receiving a clock signal for synchronizing the operation (a), and the second input/output port comprises a second clock terminal for receiving a clock signal for synchronizing the operation (b), and wherein the controller applies a first clock signal to the first clock terminal and at the same time applies a second clock signal to the second clock terminal, the first and second clock signals being different in phase or in frequency, and the controller controls the first memory so that the operations (a) and (b) overlap.

3. The data processing apparatus according to claim 2, wherein the data is read from the first memory sequentially in the order in which it was written to the first memory.

4. The data processing apparatus according to claim 3, wherein the third input/output port comprises a third clock terminal for synchronizing the operations (c) and (d), and the controller applies the second clock signal to the third clock terminal.

5. The data processing apparatus according to claim 1, wherein the first frequency is different from the second frequency.

6. The data processing apparatus according to claim 5, wherein the second frequency is n times the first frequency, where n is an integer greater than one.

7. The data processing apparatus according to claim 6, wherein the data is read from the first memory n times at the second frequency.

8. The data processing apparatus according to claim 2, wherein the first and second clock signals have the same frequency but are different in phase.

9. The data processing apparatus according to claim 2, further comprising a clock generator for generating the first and second clock signals having different frequencies.

10. The data processing apparatus according to claim 1, wherein the first memory has a smaller capacity than the second memory.

11. A data processing apparatus comprising:
a first memory which comprises a first clock terminal and a second clock terminal;
a second memory which comprises a third clock terminal; and
a controller for providing a first clock signal to the first clock terminal for writing data to the first memory, a second clock signal to the second clock terminal for reading data from the first memory, the second clock signal being different from the first clock signal, and for providing the second clock to the second memory for writing the second memory with the data read from the first memory and for reading the data from the second memory.

12. The data processing apparatus according to claim 11, wherein the first clock signal and the second clock signal are simultaneously applied to the first memory to simultaneously write and read the first memory.

13. The data processing apparatus according to claim 11, wherein the first and second clock signals are different in frequency.

14. The data processing apparatus according to claim 11, wherein the first and second clock signals are different in phase.

15. A method for controlling a data processing apparatus comprising a first memory which comprises a first input/output port and a second input/output port, the data processing apparatus also comprising a second memory which comprises a third input/output port, the method comprising:
(a) writing data to the first memory through the first input/output port;
(b) reading the data from the first memory through the second input/output port;
(c) writing the data read from the first memory to the second memory through the third input/output port; and
(d) reading the data from the second memory through the third data input/output port;
wherein operations (b), (c), (d) are performed at the same frequency.

16. The method according to claim 15, wherein the operation (a) is performed at a first frequency, and the frequency at which the operations (b), (c), (d) are performed is a second frequency which is n times the first frequency, where n is an integer greater than one, and in the operation (b) the data is read n times from the first memory at the second frequency.

17. The method according to claim 15, wherein the operation (a) is performed at the same frequency as the operations (b), (c), (d), said frequency being a frequency of a first clock signal synchronizing the operation (a) and also being a frequency of a second clock signal synchronizing the operations (b), (c), (d), the first and second clock signals being different in phase.
